(19) United States
(12) Patent Application Publication
(10) Pub. No.: US 2025/0388013 A1
(43) Pub. Date: Dec. 25, 2025

(54) LIQUID EJECTING APPARATUS AND METHOD OF ACQUIRING DETERIORATION STATE OF LIQUID EJECTING APPARATUS

(71) Applicant: SEIKO EPSON CORPORATION, Tokyo (JP)

(72) Inventor: Naoto YOKOYAMA, MATSUMOTO-SHI (JP)

(21) Appl. No.: 19/247,218

(22) Filed: Jun. 24, 2025

(30) Foreign Application Priority Data
Jun. 25, 2024 (JP) 2024-101825

(51) Int. Cl. B41J 2/045; B41J 2/14; B41J 3/44; B41J 29/20

(52) U.S. Cl. CPC B41J 2/0451; B41J 2/04541; B41J 2/04581; B41J 2/04588; B41J 2/04598; B41J 2/14233; B41J 3/44; B41J 29/20

(57) ABSTRACT

A liquid ejecting apparatus includes: a liquid ejecting head including a nozzle that ejects liquid, a pressure chamber, and a piezoelectric body that applies pressure to the liquid in the pressure chamber to eject the liquid from the nozzle; a voltage application circuit configured to apply a voltage to the piezoelectric body; and an acquisition section configured to acquire a degree of deterioration of the piezoelectric body, based on information regarding an integral value of a current generated when the voltage applied to the piezoelectric body is gradually changed from a first voltage to a second voltage.

The present application is based on, and claims priority from JP Application Serial Number 2024-101825, filed Jun. 25, 2024, the disclosure of which is hereby incorporated by reference herein in its entirety.

### BACKGROUND

### 1. Technical Field

The present disclosure relates to a liquid ejecting apparatus including a liquid ejecting head that ejects a liquid from a nozzle, and a method of acquiring a deterioration state of the liquid ejecting apparatus.

### 2. Related Art

A liquid ejecting apparatus represented by an ink jet recording apparatus such as an ink jet printer includes a liquid ejecting head capable of ejecting, as liquid droplets, liquid such as ink stored in a cartridge, a tank, or the like.

The liquid ejecting head ejects the liquid in a pressure chamber from the nozzle as liquid droplets by bending and deforming a portion which defines the pressure chamber, for example, a diaphragm, using a piezoelectric body. The displacement amount of the diaphragm by the piezoelectric body deteriorates as the liquid droplets are repeatedly ejected. Therefore, a voltage applied to the piezoelectric body is corrected according to the degree of decrease in the displacement amount, and thus the displacement amount is made equivalent to the displacement amount before deterioration. Since the degree of deterioration is affected by the number of times the piezoelectric body ejects liquid droplets, the number of times of ejecting is counted and the degree of deterioration is estimated based on the number of times of ejecting (see, for example, JP-A-2009-66948).

However, since the degree of deterioration is affected by the temperature of the environment in which the liquid droplets are ejected and the voltage applied to the piezoelectric body in addition to the number of times of ejecting, the degree of deterioration may not be accurately obtained only by estimating the degree of deterioration based on the number of times of ejecting, as disclosed in JP-A-2009-66948.

### SUMMARY

According to an aspect of the present disclosure, there is provided a liquid ejecting apparatus including: a liquid ejecting head including a nozzle configured to eject liquid, a pressure chamber, and a piezoelectric body configured to apply pressure to the liquid in the pressure chamber to eject the liquid from the nozzle; a voltage application circuit configured to apply a voltage to the piezoelectric body; and an acquisition section configured to acquire a degree of deterioration of the piezoelectric body, based on information regarding an integral value of a current generated when the voltage applied to the piezoelectric body is gradually changed from a first voltage to a second voltage.

According to another aspect of the present disclosure, there is provided a liquid ejecting apparatus including: a liquid ejecting head including a nozzle configured to eject liquid, a pressure chamber, and a piezoelectric body configured to apply pressure to the liquid in the pressure chamber to eject the liquid from the nozzle; a voltage application circuit configured to apply a voltage to the piezoelectric body; and an acquisition section configured to acquire a degree of deterioration of the piezoelectric body, based on information regarding maximum strain or residual strain of the piezoelectric body.

According to another aspect of the present disclosure, there is provided a method of acquiring a deterioration state of a liquid ejecting apparatus including a nozzle which ejects a liquid, a pressure chamber, and a piezoelectric body which applies pressure to the liquid in the pressure chamber in order to eject the liquid from the nozzle, the method including: applying a voltage which is gradually changed from a first voltage to a second voltage to the piezoelectric body; integrating a current generated by the application of the voltage to acquire information regarding an integral value; and acquiring a degree of deterioration of the piezoelectric body, based on the information.

### BRIEF DESCRIPTION OF THE DRAWINGS

FIG. 1 is a perspective view illustrating an external appearance of a liquid ejecting apparatus according to a first embodiment.

FIG. 2 is a diagram illustrating a schematic configuration of the liquid ejecting apparatus according to the first embodiment.

FIG. 3 is a sectional view of a liquid ejecting head according to the first embodiment.

FIG. 4 is a block diagram illustrating an electrical configuration of the liquid ejecting apparatus according to the first embodiment.

FIG. 5 is a block diagram illustrating functional implementation sections of a control unit according to the first embodiment.

FIG. 6 is a waveform diagram illustrating an example of a drive signal according to the first embodiment.

FIG. 7 is a graph illustrating a relationship between a parameter and a deterioration rate (dr).

FIG. 8 is a graph illustrating a butterfly curve in a piezoelectric actuator.

FIG. 9 is a hysteresis loop illustrating a relationship between voltage and current of the piezoelectric actuator.

FIG. 10 is a graph illustrating linearity before and after endurance.

FIG. 11 is a graph illustrating a relationship between a drive time and a deterioration rate of the piezoelectric actuator.

FIG. 12 is a flowchart illustrating a method of acquiring a deterioration rate of the liquid ejecting apparatus.

FIG. 13 is a view illustrating a screen of a display device according to the first embodiment.

### DESCRIPTION OF EMBODIMENTS

The present disclosure will be described in detail below based on embodiments. However, the following description indicates one aspect of the present disclosure, and can be modified as desired within the scope of the present disclosure. In each drawing, the same reference numerals denote the same components, and the description thereof will not be given as appropriate. In each drawing, X, Y, and Z represent three spatial axes that are orthogonal to each other. In the present specification, directions along these axes are referred to as an X direction, a Y direction, and a Z direction, respectively. In each drawing, a direction indicated by an arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of three spatial axes, which do not limit the positive direction and the negative direction, will be described as an X-axis direction, a Y-axis direction, and a Z-axis direction.

### First Embodiment

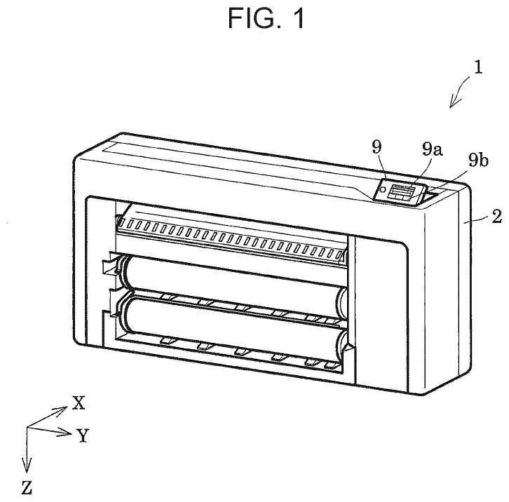

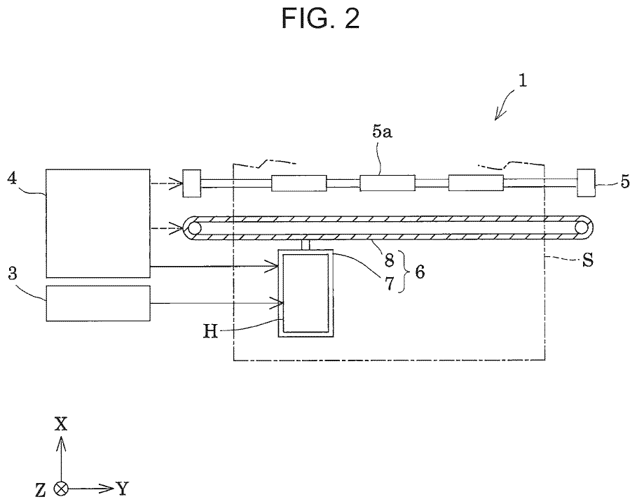

FIG. 1 is an external view of a liquid ejecting apparatus 1 according to a first embodiment of the present disclosure. FIG. 2 is a diagram illustrating a schematic configuration of the liquid ejecting apparatus 1.

As illustrated in the drawings, the liquid ejecting apparatus 1 is a so-called serial printer including a liquid ejecting head H and performing printing by transporting a medium S in an X-axis direction and ejecting liquid in a +Z direction from the liquid ejecting head H toward the medium S while causing the liquid ejecting head H to reciprocate in a Y-axis direction. An example of the medium S to be used may include any material such as recording paper or a resin film in addition to cloth.

The liquid ejecting apparatus 1 includes the liquid ejecting head H, a liquid reservoir 3, a control unit 4 which is a controller, a transport mechanism 5 which feeds out the medium S, a moving mechanism 6, and a housing 2 which houses these components.

The liquid ejecting head H ejects, as liquid droplets, in the +Z direction, liquid supplied from the liquid reservoir 3 that stores the liquid.

The liquid reservoir 3 individually stores a plurality of types of liquid having different colors and components which are to be ejected from the liquid ejecting head H. Examples of the liquid reservoir 3 include a cartridge that is detachably attached to the liquid ejecting apparatus 1, a bag-shaped ink pack formed of a flexible film, and an ink tank that can be replenished with ink. FIG. 2 illustrates one liquid reservoir 3. The liquid reservoir 3 may be a liquid reservoir 3 including separate chambers for individually storing a plurality of types of liquid, and may be a plurality of liquid reservoirs 3 provided individually according to a plurality of types of liquid. Furthermore, the liquid reservoir 3 may be divided into a main tank and a sub-tank. The liquid reservoir 3 may be configured in which the sub-tank is connected to the liquid ejecting head H, and the sub-tank is replenished with liquid from the main tank by the amount of liquid consumed by ejecting liquid droplets from the liquid ejecting head H.

The control unit 4 generally controls the respective components of the liquid ejecting apparatus 1, that is, the liquid ejecting head H, the transport mechanism 5, the moving mechanism 6, and the like.

The transport mechanism 5 transports the medium S in the X-axis direction and includes a transport roller 5a. The transport mechanism 5 transports the medium S in the X-axis direction as the transport roller 5a rotates. The transport roller 5a is rotated by a drive of a transport motor (not illustrated). The control unit 4 controls the transport of the medium S by controlling the drive of the medium transport motor. The transport mechanism 5, which transports the medium S, may transport the medium S by using, for example, a belt or a drum without being limited to the transport roller 5a.

The moving mechanism 6 is a mechanism for causing the liquid ejecting head H to reciprocate in the Y-axis direction, and includes a holding body 7 and a transport belt 8. The holding body 7 is a so-called carriage which holds the liquid ejecting head H, and is fixed to the transport belt 8. The transport belt 8 is an endless belt installed in the Y-axis direction. The transport belt 8 is rotated by a drive of a drive motor (not illustrated). The control unit 4 controls the drive of the transport motor to rotate the transport belt 8, and causes the liquid ejecting head H to reciprocate in the Y-axis direction together with the holding body 7. The holding body 7 may be configured on which the liquid reservoir 3 is mounted together with the liquid ejecting head H.

The housing 2 includes an operation panel 9 fixed to an outer periphery. The operation panel 9 includes a display device 9a, which is an example of a display section, and an operation device 9b, which is an example of a receiving section that receives an instruction from a user. The display device 9a is configured by, for example, a liquid crystal display, an organic EL display, or an LED lamp, and displays various kinds of information. The operation device 9b includes various switches capable of receiving an input from a user. Examples of the switches of the operation device 9b include a direction switch for operating a position of a cursor, a decision switch for making a decision, a cancel switch, and a power switch. The display device may be a touch panel capable of receiving an input from the user. In a case of a touch panel, the touch panel serves as both the display section and the receiving section.

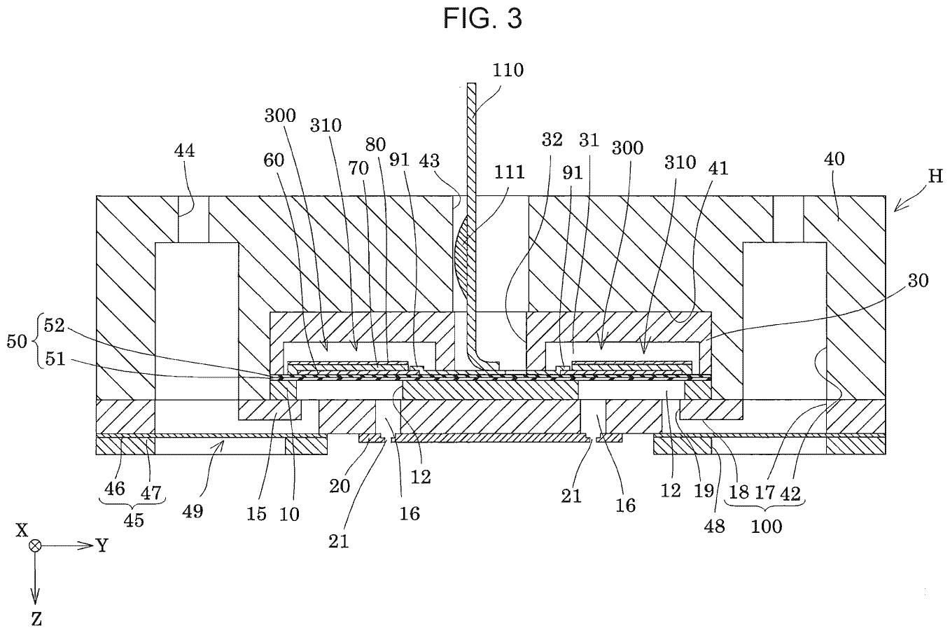

Under the control of the control unit 4, the liquid ejecting head H performs an ejecting operation of ejecting, in the +Z direction, as liquid droplets, the liquid supplied from the liquid reservoir 3 from each of a plurality of nozzles 21 (see FIG. 3). The ejecting operation by the liquid ejecting head H is performed in parallel with the transport of the medium S by the transport mechanism 5 and the reciprocating movement of the liquid ejecting head H by the moving mechanism 6, and thus the liquid is applied onto the medium S, that is, so-called printing is performed.

FIG. 3 is a sectional view of the liquid ejecting head H. In addition, each direction of the liquid ejecting head H will be described based on directions when the liquid ejecting head H is mounted on the liquid ejecting apparatus 1, that is, an X-axis direction, a Y-axis direction, and a Z-axis direction.

As illustrated in the drawing, the liquid ejecting head H includes a flow-path forming substrate 10, a communicating plate 15, a nozzle plate 20 in which the plurality of nozzles 21 are formed, a protective substrate 30, a case member 40, and a piezoelectric actuator 300.

The flow-path forming substrate 10 includes, for example, a silicon substrate, a glass substrate, an SOI substrate, or various ceramic substrates. In the flow-path forming substrate 10, a plurality of pressure chambers 12 are disposed side by side in the X-axis direction. The plurality of pressure chambers 12 are disposed on a straight line in the X-axis direction to be at the same position in the Y-axis direction. In the present embodiment, two pressure chamber rows, in which the pressure chambers 12 are disposed side by side in the X-axis direction, are provided in the Y-axis direction. The pressure chambers 12 constituting these two pressure chamber rows are disposed at the same position in the X-axis direction. The two pressure chamber rows may be disposed to be shifted from each other in the X-axis direction by half the pitch of the pressure chambers 12, that is, by a so-called half pitch. In other words, all the pressure chambers 12 in the two pressure chamber rows may be disposed in a staggered manner in the X-axis direction.

The communicating plate 15 and the nozzle plate 20 are sequentially stacked on the surface of the flow-path forming substrate 10 facing the +Z direction. A diaphragm 50 and the piezoelectric actuator 300 are sequentially stacked on the surface of the flow-path forming substrate 10 facing the −Z direction.

The communicating plate 15 is formed of a plate-shaped member bonded to the surface of the flow-path forming substrate 10 facing the +Z direction. The communicating plate 15 is provided with a nozzle communication path 16 that allows the pressure chamber 12 and the nozzle 21 to communicate with each other. In addition, the communicating plate 15 is provided with a first manifold portion 17 and a second manifold portion 18 which constitute a part of a manifold 100 serving as a common liquid chamber with which the plurality of pressure chambers 12 communicate in common. The first manifold portion 17 is provided to pass through the communicating plate 15 in the Z-axis direction. Further, the second manifold portion 18 is provided to be open on the surface facing the +Z direction without passing through the communicating plate 15 in the Z-axis direction. Furthermore, the communicating plate 15 is provided with a supply communication path 19, which communicates with the pressure chamber 12, independently for each of the pressure chambers 12. The supply communication path 19 communicates between the second manifold portion 18 and the pressure chamber 12 to supply the ink in the manifold 100 to the pressure chamber 12. As the communicating plate 15, a silicon substrate, a glass substrate, an SOI substrate, various ceramic substrates, a metal substrate such as a stainless steel substrate, or the like is used.

The nozzle plate 20 is bonded to a side of the communicating plate 15 opposite to the flow-path forming substrate 10, that is, to the surface facing the +Z direction. The nozzle plate 20 includes a plurality of nozzles 21 formed therein, which communicate with the pressure chambers 12 through the nozzle communication paths 16. In the present embodiment, the plurality of nozzles 21 are disposed side by side in a row in the X-axis direction for each pressure chamber row. That is, in the present embodiment, two nozzle rows, in which the nozzles 21 are disposed side by side in the X-axis direction, are provided spaced apart in the Y-axis direction. The nozzles 21 constituting the two nozzle rows are disposed to be at the same position in the X-axis direction. Naturally, when the two pressure chamber rows are disposed at positions shifted from each other by half the pitch of the pressure chambers 12 in the X-axis direction, the two nozzle rows may also be similarly disposed at positions shifted from each other by half the pitch of the nozzles 21 in the X-axis direction. In other words, all of the nozzles 21 in the two nozzle rows may be disposed in a staggered manner in the X-axis direction.

Such a nozzle plate 20 may be made of a silicon substrate, a glass substrate, an SOI substrate, various ceramic substrates, a metal substrate such as a stainless steel substrate, an organic material such as a polyimide resin, or the like is used. The surface of the nozzle plate 20 facing the +Z direction constitutes a part of the ejecting surface of the liquid ejecting head H.

In the present embodiment, the diaphragm 50 includes an elastic film 51 that is provided on the flow-path forming substrate 10 and is made of silicon oxide, and an insulator film 52 that is provided on a surface of the elastic film 51 facing the −Z direction and is made of zirconium oxide. The diaphragm 50 may include only the elastic film 51, may include only the insulator film 52, or may include another film in addition to the elastic film 51 and the insulator film 52.

The piezoelectric actuator 300 includes a first electrode 60, a piezoelectric layer 70, and a second electrode 80 that are sequentially stacked on the diaphragm 50 in the −Z direction. The piezoelectric actuator 300 corresponds to a “piezoelectric body” that applies pressure to the ink in the pressure chamber 12 in order to eject liquid from the nozzle 21. Such a piezoelectric actuator 300 refers to a portion including the first electrode 60, the piezoelectric layer 70, and the second electrode 80. A portion, where a piezoelectric strain occurs in the piezoelectric layer 70 when a voltage is applied between the first electrode 60 and the second electrode 80, is referred to as an active portion 310. In other words, the active portion 310 refers to a portion where the piezoelectric layer 70 is interposed between the first electrode 60 and the second electrode 80. In the present embodiment, the active portion 310 is formed for each of the pressure chambers 12. In general, one of the electrodes for the active portion 310 is configured as an individual electrode independent of each of the active portions 310, and the other electrode is configured as a common electrode shared by the plurality of active portions 310. In the present embodiment, the first electrode 60 is separated for each active portion 310 to form an individual electrode for the active portion 310, and the second electrode 80 is continuously provided over the plurality of active portions 310 to form a common electrode for the plurality of active portions 310. The first electrode 60 may form a common electrode, and the second electrode 80 may form an individual electrode.

The piezoelectric layer 70 is formed, for example, using a piezoelectric material made of a composite oxide having a perovskite structure represented by the general formula ABO₃.

An individual lead electrode 91, which is lead-out wiring, is led out from the first electrode 60. A common lead electrode, which is lead-out wiring (not illustrated), is led out from the second electrode 80. A wiring substrate 110 having flexibility is connected to end portions of these individual lead electrode 91 and common lead electrode opposite to end portions connected to the piezoelectric actuator 300. The wiring substrate 110 is mounted with a drive signal selection circuit 111 having a plurality of switching elements for selecting whether to supply a drive signal (COM) for driving each of the active portions 310 to each of the active portions 310. In other words, the wiring substrate 110 in the present embodiment is a Chip on Film (COF). The wiring substrate 110 may not be provided with the drive signal selection circuit 111. In other words, the wiring substrate 110 may be a flexible flat cable (FFC), a flexible printed circuit (FPC), and the like.

Further, a protective substrate 30 having substantially the same size as that of the flow-path forming substrate 10 is bonded to the surface of the flow-path forming substrate 10 facing the −Z direction. The protective substrate 30 has an accommodation portion 31 which is a space for protecting the piezoelectric actuator 300. The accommodation portion 31 is independently provided for each row of the piezoelectric actuators 300 disposed side by side in the X-axis direction, and two accommodation portions 31 are formed side by side in the Y-axis direction. The protective substrate 30 is provided with a through hole 32 extending in the Z-axis direction between the two accommodation portions 31 disposed side by side in the Y-axis direction. End portions of the individual lead electrode 91 and the common lead electrode (not illustrated) which are led out from the electrode of the piezoelectric actuator 300 extend so as to be exposed in the through hole 32, and the individual lead electrode 91 and the common lead electrode are electrically connected to the wiring substrate 110 within the through hole 32. Similarly to the flow-path forming substrate 10, an example of the protective substrate 30 includes a silicon substrate, a glass substrate, an SOI substrate, or various ceramic substrates.

In addition, the case member 40 is fixed on the protective substrate 30 to define a part of a manifold 100 which communicates with the plurality of pressure chambers 12. The case member 40 has substantially the same shape as the communicating plate 15 described above in a plan view, and is bonded not only to the protective substrate 30, but also to the communicating plate 15 described above. Such a case member 40 includes a recess 41 on the protective substrate 30, the recess 41 having a depth sufficient to accommodate the flow-path forming substrate 10 and the protective substrate 30. The case member 40 is also provided with a third manifold portion 42 that communicates with the first manifold portion 17 of the communicating plate 15. The manifold 100 of the present embodiment is formed by the first manifold portion 17 and the second manifold portion 18 provided in the communicating plate 15 and the third manifold portion 42 provided in the case member 40. The manifold 100 is provided for each nozzle row. In other words, different types of ink can be ejected from each nozzle row. In addition, an introduction port 44 is provided in the case member 40 to communicate with the manifold 100 and supply ink to each manifold 100. In addition, the case member 40 is provided with a connection port 43 that communicates with the through hole 32 of the protective substrate 30 and through which the wiring substrate 110 is inserted, and the wiring substrate 110 is led out toward the surface of the liquid ejecting head H facing the −Z direction through the connection port 43. The case member 40 may be made of, for example, a metal material or a resin material.

A compliance substrate 45 is provided on the surface facing the +Z direction side on which the first manifold portion 17 and the second manifold portion 18 of the communicating plate 15 are opened. The compliance substrate 45 seals the openings of the first manifold portion 17 and the second manifold portion 18 on the +Z direction side. In the present embodiment, such a compliance substrate 45 includes a sealing film 46 made of a flexible thin film, and a fixed substrate 47 made of a hard material such as metal. An opening portion 48, which is completely removed in the thickness direction, is provided in a region of the fixed substrate 47 facing the manifold 100, and one surface of the manifold 100 is a compliance portion 49 which is a flexible portion sealed only by the sealing film 46 having flexibility.

In such a liquid ejecting head H, liquid is taken in from the introduction port 44, and the inside of the flow path from the manifold 100 to the nozzle 21 is filled with ink. Thereafter, a voltage is applied to each active portion 310 corresponding to the pressure chamber 12 according to a signal from the drive signal selection circuit 111, and thus the diaphragm 50 is bent and deformed along with the piezoelectric actuator 300. Thus, the pressure of the liquid in the pressure chamber 12 increases, and liquid droplets are ejected from a predetermined nozzle 21.

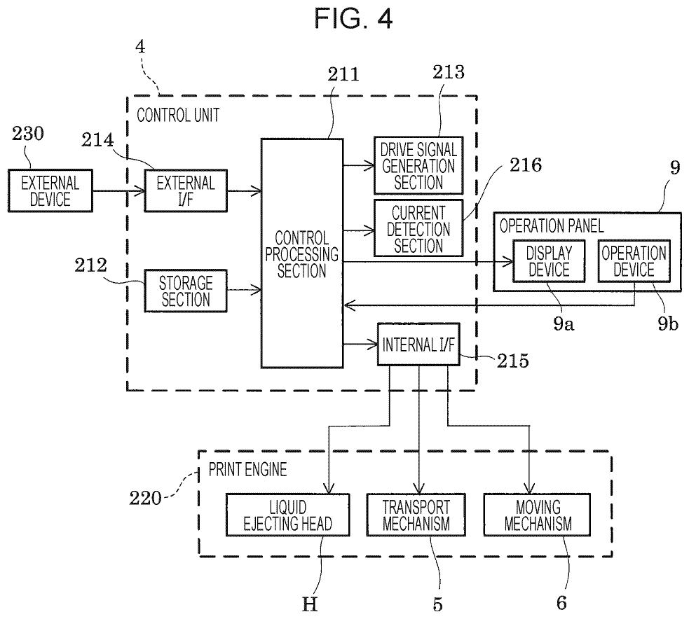

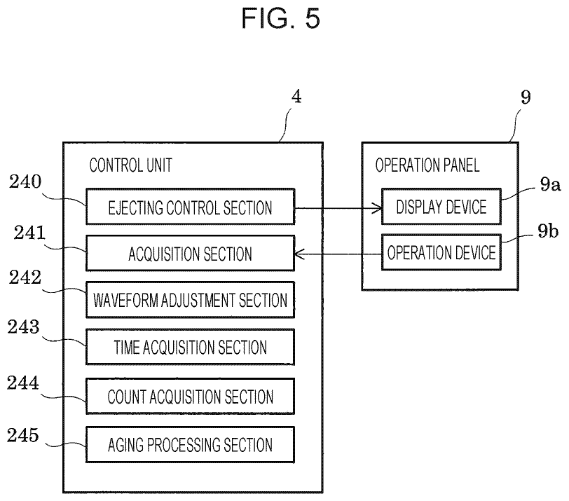

FIG. 4 is a block diagram illustrating an electrical configuration of the liquid ejecting apparatus 1 according to the embodiment. FIG. 5 is a block diagram illustrating functional implementation sections of the control unit 4. An electrical configuration and functions of the liquid ejecting apparatus 1 according to the embodiment will be described with reference to FIGS. 4 and 5.

As illustrated in FIG. 4, the liquid ejecting apparatus 1 includes a control unit 4 which is a controller of the present embodiment, a print engine 220, and an operation panel 9.

The control unit 4 is a component that controls the liquid ejecting apparatus 1 as a whole. The control unit 4 includes a control processing section 211, a storage section 212, a drive signal generation section 213, an external interface (I/F) 214, an internal I/F 215, and a current detection section 216. The control processing section 211 includes, for example, a CPU. The storage section 212 includes a ROM that records a control program and the like, and a RAM that temporarily records various kinds of data necessary for printing an image. The control processing section 211 generally controls each component of the liquid ejecting apparatus 1 by executing a control program recorded in the storage section 212, and further implements each function. The drive signal generation section 213 is an example of a “voltage application circuit”.

Print data indicating an image to be printed on the medium S is transmitted from the external device 230 such as a host computer to the external I/F 214 of the control unit 4, and the print engine 220 is connected to the internal I/F 215. The print engine 220 is an element for recording an image on a medium S under the control of the control unit 4, and includes the liquid ejecting head H, the transport mechanism 5, and the moving mechanism 6.

The control unit 4 has functions as an ejecting control section 240, an acquisition section 241, a waveform adjustment section 242, a time acquisition section 243, a count acquisition section 244, and an aging processing section 245.

The ejecting control section 240 controls ejecting of liquid droplets from the nozzles 21. Specifically, the control processing section 211 converts the print data transmitted from the external device 230 to the external I/F 214 into a head control signal, for example, a clock signal CLK, a latch signal LAT, a change signal CH, pixel data SI, or setting data SP for instructing each of the active portions 310 to eject or not to eject liquid droplets from each nozzle 21 of the liquid ejecting head H, and transmits the converted signal or data to the liquid ejecting head H via the internal I/F 215. Further, the drive signal generation section 213 generates a drive signal (COM) and transmits it to the liquid ejecting head H via the internal I/F 215. Namely, ejecting data such as head control data and the drive signal are transmitted to the liquid ejecting head H via the internal I/F 215 which is a transmission section.

The liquid ejecting head H, to which the ejecting data such as the head control signal and the drive signal are supplied from the control unit 4, generates an application pulse from the head control signal and the drive signal and applies the application pulse to the active portion 310.

In addition, the control processing section 211 generates a movement control signal of the transport mechanism 5 and the moving mechanism 6 from the print data received from the external device 230 via the external I/F 214, transmits the movement control signal to the transport mechanism 5 and the moving mechanism 6 via the internal I/F 215, and controls the transport mechanism 5 and the moving mechanism 6. Thus, printing on the medium S is executed.

The current detection section 216 is a circuit that applies a current detection signal to the piezoelectric actuator 300 to drive the piezoelectric actuator 300 and outputs, as a signal, an integral value of the current flowing through the piezoelectric actuator 300 while the current detection signal is being applied. Hereinafter, the integral value of the current output by the current detection section 216 is referred to as a current integral value. The current integral value is referenced by the acquisition section 241, which will be described below. The current detection signal is a signal indicating a current detected when the voltage is gradually changed from a first voltage to a second voltage. The first voltage and the second voltage are set by the acquisition section 241, which will be described below, and the current detection section 216 drives the piezoelectric actuator 300 with a current detection signal corresponding to the first voltage and the second voltage. Although the piezoelectric actuator 300 includes a plurality of active portions 310, the current detection signal may be provided to all of the active portions 310 or may be provided to some of the active portions 310. Here, the first voltage and the second voltage indicate a differential pressure actually applied to the piezoelectric layer 60, that is, a difference between the voltage applied to the first electrode 60 and the voltage applied to the second electrode.

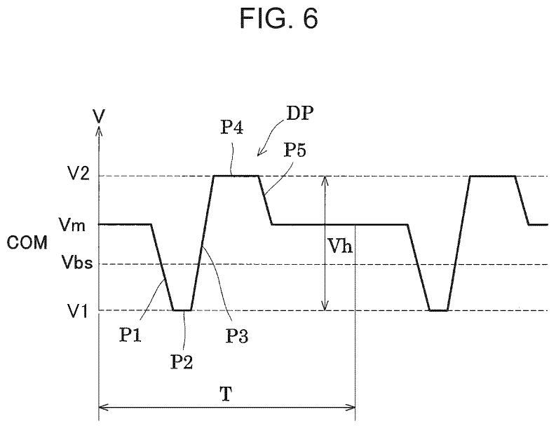

FIG. 6 is a waveform diagram illustrating the drive signal of the present embodiment. An example of a driving signal for ejecting ink droplets will be described with reference to FIG. 6.

The drive signal (COM) generated by the drive signal generation section 213 has a drive pulse that causes ink droplets to be ejected from the nozzle 21 within one recording cycle T (frequency 1/T).

In FIG. 6, a drive waveform DP is a relative value of a potential supplied to the first electrode 60, which is an individual electrode, when the second electrode 80, which is a common electrode of the plurality of active portions 310, is set to a reference potential Vbs as a reference. Namely, the voltage applied to the first electrode 60 by the drive waveform is equal to the sum of the drive waveform DP indicated by a solid line in FIG. 6 and the reference potential Vbs indicated by a broken line in FIG. 6.

The drive waveform DP includes, in this order, an expansion element P1, an expansion maintenance element P2, a contraction element P3, a contraction maintenance element P4, and an expansion return element P5. A voltage of the expansion element P1 is a potential difference between a potential indicated by the expansion element P1 and the reference potential Vbs, and corresponds to an “expansion voltage”. A voltage of the contraction element P3 is a potential difference between a potential indicated by the contraction element P3 and the reference potential Vbs, and corresponds to a “contraction voltage”. A voltage of an intermediate potential Vm is a potential difference between an intermediate potential Vm and the reference potential Vbs, and corresponds to an “intermediate voltage”.

The expansion element P1 applies a potential from a state where the intermediate potential Vm is applied to a first potential V1, thereby expanding the volume of the pressure chamber 12 from the reference volume. A meniscus of the ink formed in the nozzles 21 are drawn into the pressure chamber 12 by the expansion element P1, and the ink is supplied from the manifold 100 to the pressure chamber 12.

The expansion maintenance element P2 maintains the volume of the pressure chamber 12 expanded by the expansion element P1 for a certain period of time.

The contraction element P3 contracts the volume of the pressure chamber 12 by applying the potential difference Vh from the first potential V1 to the second potential V2. The volume of the pressure chamber 12 is rapidly contracted by the contraction element P3, and the ink in the pressure chamber 12 is pressurized and ejected as an ink droplet from the nozzle 21.

The contraction maintenance element P4 maintains the volume of the pressure chamber 12 contracted by the contraction element P3, for a certain period of time.

The expansion return element P5 expands and returns the pressure chamber 12 from the contracted state of the second potential V2 to the reference volume at the intermediate potential Vm. The expansion return element P5 is supplied at a timing at which the pressure of the ink in the pressure chamber 12, which has been reduced in the contraction element P3, rises again due to a natural vibration of the meniscus in the contraction maintenance element P4. When the expansion return element P5 is supplied at such a timing, a pressure fluctuation in the ink in the pressure chamber 12 is absorbed. In such a drive waveform DP, the minimum voltage applied to the piezoelectric layer 60 is the first potential V1, and specifically has a value being approximately −3.5 [V]. In addition, the maximum voltage applied to the piezoelectric layer is the second potential V2, and specifically has a value being approximately 35 [V]. The reason why this value is set will be described later.

The acquisition section 241 acquires the degree of deterioration of the piezoelectric actuator 300. The degree of deterioration of the piezoelectric actuator 300 is defined as follows, for example.

When the displacement amount when the piezoelectric actuator 300 starts to be driven is defined as a first displacement amount, and the displacement amount after a voltage is applied for a certain driving time is defined as a second displacement amount, the degree of deterioration of the piezoelectric actuator 300 is a ratio calculated by (second displacement amount-first displacement amount)/first displacement amount. Hereinafter, such a ratio is referred to as a deterioration rate. Regarding the deterioration rate, since the more the piezoelectric actuator 300 is driven, the more the displacement amount decreases, the displacement amount after voltage application becomes smaller than the displacement amount at the start of driving. Therefore, the drive change rate is a negative value. The displacement amount corresponds to an amplitude of the diaphragm 50 which is bent and deformed by the deformation of the piezoelectric actuator 300. In other words, the displacement amount corresponds to a distance in the Z-axis direction between a portion where the diaphragm 50 is most bent toward the +Z direction side and a portion where the diaphragm 50 is most bent toward the −Z direction side.

It has been clarified by the analysis of the present inventors that the deterioration rate correlates with the change rate of the following parameters.

### Parameter Pm

The parameter Pm is a value indicating the maximum strain and tends to decrease with deterioration. The parameter Pm is due to a fixation of a polarization axis (fatigue deterioration) caused by the movement of oxygen defects and a change in crystal structure (change in domain structure). The parameter Pm can be obtained from a time integral value of the current amount from the minimum voltage to the maximum voltage at the time of driving the piezoelectric actuator 300. Since the contraction element P3 of the drive waveform DP illustrated in FIG. 6 is an element that changes from the minimum potential V1, which is the minimum voltage, to the maximum potential V2, which is the maximum voltage, the parameter Pm can be easily obtained by applying the drive waveform DP, detecting the current flowing during the contraction element P3, and integrating the current over time.

### Parameter Pr

The parameter Pr is a value indicating a residual strain and tends to decrease with deterioration. The parameter Pr is due to the influence of a shift in coercive voltage caused by the movement of oxygen defects and a change in crystal structure (change in domain structure). The parameter Pr can be obtained by a time integral value of a current amount from the minimum voltage to 0 [V].

### Parameter Pm-Pr

The parameter Pm-Pr is a value approximate to a dielectric constant and tends to decrease with deterioration. The parameter Pm-Pr is due to complex factors of the parameter Pm and the parameter Pr. The parameter Pm-Pr can be obtained from the time integral value of the current amount from 0 [V] to the maximum voltage.

Unlike the parameter Pm, the parameter Pr and the parameter Pm-Pr do not have an element in the drive waveform DP that changes within a voltage range required for detection thereof, and thus it is theoretically possible to measure the parameters Pr and Pm-Pr without an error using the drive waveform DP (for example, it is sufficient to detect a current from the middle of the contraction element P3 to the middle), but it is actually difficult to measure the parameters Pr and Pm-Pr without an error. Therefore, it is preferable to prepare a waveform for detection separately from the drive waveform DP.

For example, it is preferable to prepare a waveform that changes from the minimum voltage to 0 [V] to detect the parameter Pr, and a waveform that changes from 0 [V] to the maximum voltage to detect the parameter pm-Pr. When one of the parameter Pr and the parameter Pm-Pr is obtained, the other can also be obtained by taking the difference between the one thereof and the parameter Pm.

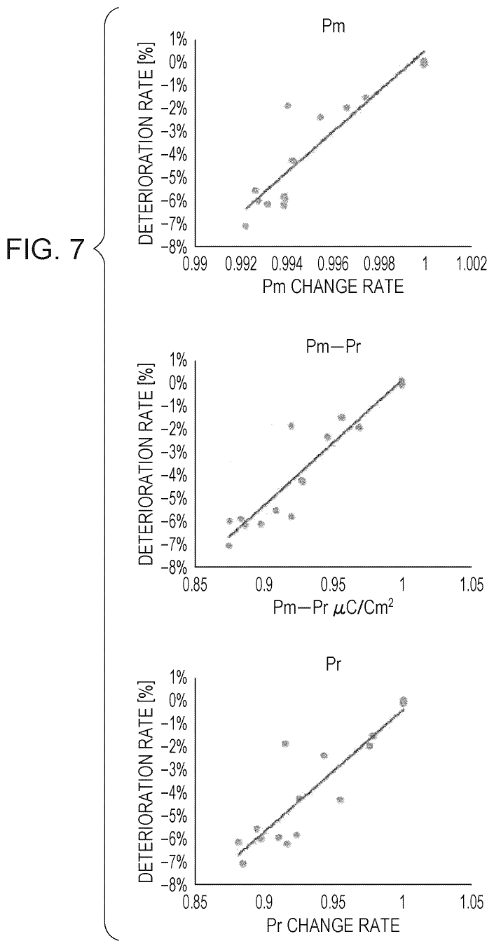

As described above, the information regarding the time integral value of the current flowing through the piezoelectric actuator 300 indicates parameters such as the parameters Pm, Pm-Pr, and Pr described above. As will be described below with reference to FIG. 7, these parameters are information that tends to decrease as the displacement amount of the piezoelectric actuator 300 deteriorates. In the present embodiment, it is sufficient to acquire at least one of the parameters Pm, Pm-Pr, and Pr.

FIG. 7 illustrates a relationship between each parameter and a deterioration rate (dr). A horizontal axis represents a change rate of each parameter, and a vertical axis represents a deterioration rate. As illustrated in this drawing, the deterioration rate and the change rate of each parameter have a positive correlation from experiments. Therefore, it has been found that the deterioration rate can be obtained when the change rate of the parameter can be obtained. When the value of the parameter at the time of starting the driving of the piezoelectric actuator 300 is defined as an initial parameter and the parameter obtained after that time is defined as a post-drive parameter, the change rate of the parameter is a ratio calculated by (post-drive parameter/initial parameter). Details of the timing at which the post-drive parameter is obtained will be described below.

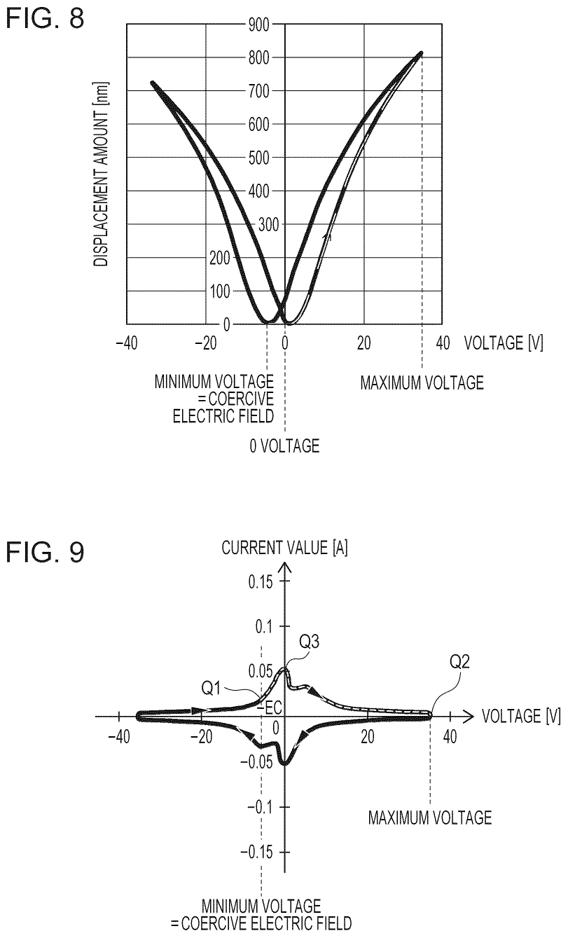

A method of acquiring the parameter Pm will be described with reference to FIGS. 8 and 9. FIG. 8 is a butterfly curve in the piezoelectric actuator 300 of the present embodiment. FIG. 9 is a hysteresis loop illustrating a relationship between the voltage and current of the piezoelectric actuator 300 of the present embodiment. In FIG. 8, a horizontal axis represents a voltage [V], and a vertical axis represents a displacement amount [nm] of the diaphragm 50. In FIG. 9, a horizontal axis represents a voltage [V], and a vertical axis represents a current value [A].

As illustrated in FIG. 8, the piezoelectric actuator 300 of the present embodiment has a minimum voltage (coercive electric field) of approximately −3.5 [V] and a maximum voltage of approximately 35 [V]. The minimum voltage is substantially equal to the coercive electric field of the piezoelectric actuator 300, and the maximum voltage is substantially equal to the voltage at which the piezoelectric actuator 300 is saturated and polarized. When the current detection signal, in which the minimum voltage is defined as the first voltage and the maximum voltage is defined as the second voltage, is applied to the piezoelectric actuator 300, the displacement amount reaches from zero to approximately 800 [nm], resulting in maximum strain. Since the piezoelectric actuators 300 of the present embodiment have such electrical characteristics, in order to make the displacement as large as possible, the first potential V1, which is the minimum voltage, in the drive waveform DP illustrated in FIG. 6 is set to approximately −3.5 [V] and the second potential V2, which is the maximum voltage, is set to approximately 35 [V]. On the other hand, as illustrated in FIG. 9, when the current detection signal is applied to the piezoelectric actuators 300, a current flows in the piezoelectric actuators 300 as indicated by a path from a point Q1 to a point Q2 on the hysteresis loop (a path passing through a point Q3). The current detection section 216 integrates the current value in a range from the point Q1 to the point Q2 in the hysteresis loop. Namely, the parameter Pm is a current integral value, which is an area between the horizontal axis and the path from the point Q1 to the point Q2.

When the current detection signal, in which the first voltage is the minimum voltage and the second voltage is the maximum voltage, is applied to the piezoelectric actuator 300, the displacement amount of the diaphragm 50 of the piezoelectric actuator 300 changes from zero to the maximum strain. Therefore, the parameter Pm, which is an integral value of the current flowing in the piezoelectric actuator 300 while the current detection signal is being applied, becomes a value indicating the maximum strain. Although the parameter Pm is not a value representing the maximum strain itself, a change in the parameter Pm represents a change in the maximum strain. For example, when the piezoelectric actuator 300 deteriorates and the maximum strain decreases, the parameter Pm also decreases accordingly. Namely, as illustrated in FIG. 7, there is a positive correlation between the change rate of the parameter Pm and the deterioration rate of the piezoelectric actuator 300. In this embodiment, since the drive waveform DP as illustrated in FIG. 6 is used, the first voltage serving as the minimum voltage is the minimum potential V1 in FIG. 6, and the second voltage serving as the maximum voltage is the maximum potential V2 in FIG. 6.

Based on such a principle, the acquisition section 241 acquires the deterioration rate based on the parameter Pm as follows. First, the relationship between the deterioration rate and the change rate of the parameter as illustrated in FIG. 7 is obtained in advance by experiments or simulations. Then, the relationship between the deterioration rate and the change rate of the parameter is stored in the storage section 212. For example, a correspondence table of the relationship between the deterioration rate and the change rate of the parameter is stored in the storage section 212. Alternatively, a relational expression between the deterioration rate and the change rate of the parameter is stored in the storage section 212. The relationship between the deterioration rate and the change rate of the parameter is specific to the structure of the liquid ejecting head H or the like. Therefore, the above-described relationship can be commonly used in the liquid ejecting apparatus 1 that employs the liquid ejecting head H having the same structure.

The acquisition section 241 sets the minimum voltage as the first voltage and the maximum voltage as the second voltage, causes the current detection section 216 to generate a current detection signal based on the first voltage and the second voltage, and applies the current detection signal to the piezoelectric actuator 300. The current detection section 216 outputs the integral value of the current flowing in the piezoelectric actuator 300 according to the current detection signal. The acquisition section 241 sets, as the parameter Pm, the current integral value output by the current detection section 216. The timing at which the parameter Pm is acquired is when the driving of the piezoelectric actuator 300 starts and after that time. Assuming that the parameter Pm obtained at the former timing is the initial parameter Pm and the parameter Pm obtained at the latter timing is the post-drive parameter Pm, it is possible to obtain the change rate of the parameter Pm by calculating (post-drive parameter Pm/initial parameter Pm). The initial parameter Pm is stored in the storage section 212 or the like when, for example, the liquid ejecting head H is manufactured or shipped. Further, the timing at which the post-drive parameter Pm is obtained is arbitrary, but is preferably, for example, a timing at which waveform adjustment is performed based on the deterioration rate.

Next, every time the post-drive parameter Pm is acquired, the acquisition section 241 reads the initial parameter Pm to obtain the change rate of the parameter Pm, and acquires the deterioration rate from the correspondence table or the relational expression stored in the storage section 212. For example, when the correspondence table is used, the deterioration rate corresponding to the change rate of the parameter Pm is read from the correspondence table. When the relational expression is used, the deterioration rate is obtained by substituting the change rate of the parameter Pm into the relational expression. In this way, the acquisition section 241 acquires the post-drive parameter Pm at any timing after shipment, for example, at a timing at which waveform adjustment is performed, and acquires the deterioration rate corresponding to the post-drive parameter Pm.

A method of acquiring the parameter Pm-Pr will be described.

As illustrated in FIG. 8, the first voltage is set to zero [V] and the second voltage is set to the maximum voltage, and the current detection signal based on the first voltage and the second voltage is generated in the current detection section 216 and is applied to the piezoelectric actuator 300. As illustrated in FIG. 9, when the current detection signal is applied to the piezoelectric actuator 300, a current flows through the piezoelectric actuator 300 as indicated by a path from a point Q3 to a point Q2 on the hysteresis loop. The current detection section 216 integrates the current value in the range from the point Q3 to the point Q2 on the hysteresis loop. In other words, the current integral value, which is an area between the horizontal axis and the path from the point Q3 to the point Q2, is the parameter Pm-Pr.

The parameter Pm-Pr is a value approximate to a dielectric constant, and tends to decrease with deterioration. When the piezoelectric actuator 300 deteriorates and the displacement amount decreases, the parameter Pm-Pr also decreases accordingly. Namely, as illustrated in FIG. 7, there is a positive correlation between the change rate of the parameter Pm-Pr and the deterioration rate of the piezoelectric actuator 300.

The acquisition section 241 sets the first voltage to zero and the second voltage to the maximum voltage, causes the current detection section 216 to generate a current detection signal based on the first voltage and the second voltage, and applies the current detection signal to the piezoelectric actuator 300. The current detection section 216 outputs the integral value of the current flowing in the piezoelectric actuator 300 according to the current detection signal. The acquisition section 241 sets the current integral value output by the current detection section 216 as the parameter Pm-Pr. The timing at which such a parameter Pm-Pr is acquired is when the driving of the piezoelectric actuator 300 starts and after that time. Assuming that the parameter Pm-Pr obtained at the former timing is the initial parameter Pm-Pr and the parameter Pm-Pr obtained at the latter timing is the post-drive parameter Pm-Pr, it is possible to obtain the rate of change of the parameter Pm-Pr by calculating (post-drive parameter Pm-Pr/initial parameter Pm-Pr). The initial parameter Pm-Pr is stored in the storage section 212 or the like when, for example, the liquid ejecting head H is manufactured or shipped. Further, the timing at which the post-drive parameter Pm-Pr is obtained is arbitrary, but is preferably, for example, a timing at which waveform adjustment is performed based on the deterioration rate.

Next, every time the post-drive parameter Pm-Pr is acquired, the acquisition section 241 reads the initial parameter Pm-Pr, obtains the change rate of the parameter Pm-Pr, and acquires the deterioration rate from the correspondence table or the relational expression stored in the storage section 212.

A method of acquiring the parameter Pr will be described.

As illustrated in FIG. 8, the minimum voltage is set as the first voltage and zero [V] is set as the second voltage, and the current detection signal based on the first voltage and the second voltage is generated in the current detection section 216 and is applied to the piezoelectric actuator 300. As illustrated in FIG. 9, when the current detection signal is applied to the piezoelectric actuators 300, a current flows through the piezoelectric actuators 300 as indicated by a path from a point Q1 to a point Q3 on the hysteresis loop. The current detection section 216 integrates the current value in a range from the point Q1 to the point Q3 in the hysteresis loop. Namely, the parameter Pr is a current integral value which is an area between the horizontal axis and the path from the point Q1 to the point Q3. Instead of obtaining the integral value of the current value, the parameter Pr may be obtained by separately obtaining the parameter Pm and the parameter Pm-Pr described above and subtracting the parameter Pm-Pr from the parameter Pm.

The parameter Pr is a value indicating a residual strain, and tends to decrease with deterioration. When the piezoelectric actuator 300 deteriorates and the displacement amount decreases, the parameter Pr also decreases accordingly. Namely, as illustrated in FIG. 7, there is a positive correlation between the change rate of the parameter Pr and the deterioration rate of the piezoelectric actuator 300.

The acquisition section 241 sets the minimum voltage as the first voltage and 0 [V] as the second voltage, causes the current detection section 216 to generate a current detection signal based on the first voltage and the second voltage, and applies the current detection signal to the piezoelectric actuator 300. The current detection section 216 outputs the integral value of the current flowing in the piezoelectric actuator 300 according to the current detection signal. The acquisition section 241 sets the current integral value output by the current detection section 216 as the parameter Pr. The timing at which such a parameter Pr is acquired is when the driving of the piezoelectric actuator 300 starts and after that time. Assuming that the parameter Pr obtained at the former timing is the initial parameter Pr and the parameter Pr obtained at the latter timing is the post-drive parameter Pr, it is possible to obtain the change rate of the parameter Pr by calculating (post-drive parameter Pr/initial parameter Pr). The initial parameter Pr is stored in the storage section 212 when, for example, the liquid ejecting head H is manufactured or shipped. Further, the timing at which the post-drive parameter Pr is obtained is arbitrary, but is preferably, for example, a timing at which waveform adjustment is performed based on the deterioration rate.

Next, the acquisition section 241 acquires the deterioration rate from the change rate of the parameter Pr and the correspondence table or the relational expression stored in the storage section 212. For example, when the correspondence table is used, the deterioration rate corresponding to the change rate of the parameter Pr is read from the correspondence table. When the relational expression is used, the deterioration rate is obtained by substituting the change rate of the parameter Pr into the relational expression.

The waveform adjustment section 242 adjusts the drive waveform according to the above-described deterioration rate of the piezoelectric actuator 300 acquired by the acquisition section 241. Specifically, the waveform adjustment section 242 applies the deterioration rate dr and the potential difference Vh in the drive waveform DP (hereinafter, also referred to as a reference Vh) to Expression 1, thereby calculating a potential difference Vh after correction (hereinafter, referred to as corrected Vh).

Corrected Vh=A(1/(1+dr))−1)²+B((1/(1+dr))−1)+C (Expression 1)

A=As×Vh+Ai

B=Bs×Vh+Bi

C=Cs×Vh+Ci

The coefficients As, Bs, Cs, Ai, Bi, and Ci are values determined based on linearity of the piezoelectric actuator 300, and details thereof will be described below. As described above, Expression 1 and coefficients A to C used in Expression 1 are stored in a memory (not illustrated) provided in the liquid ejecting head H, the storage section 212 of the control unit 4, a memory of the external device 230, a cloud, or the like. The waveform adjustment section 242 calculates the corrected Vh by applying the coefficients A to C read from the memories, the reference Vh used for the drive waveform DP, and the deterioration rate dr acquired by the acquisition section 241 to Expression 1. Then, the waveform adjustment section 242 changes the reference Vh of the drive waveform DP to the corrected Vh.

The waveform adjustment section 242 may obtain the corrected Vh based on the correction amount instead of the deterioration rate. The correction amount dc is obtained by Expression 2.

dc=(1/(1+dr))−1 (Expression 2)

For example, when the deterioration rate is −0.05, the correction amount is approximately 0.053. That is, in order to restore the displacement amount to the original displacement amount when the displacement amount is deteriorated by 5%, it is necessary to correct the drive waveform DP so as to increase the displacement amount by approximately 5.3%. The corrected Vh can be obtained by substituting the correction amount dc into Expression (3) obtained by substituting Expression (2) into Expression (1).

Corrected Vh=Adc2+Bdc+C (Expression 3)

The adjustment of the drive waveform using the above-described Expression 1 will be described. As indicated in Expression 4, it is empirically known that the displacement amount of the piezoelectric actuator 300 can be linearly approximated to a logarithm of the voltage. Such a characteristic that the displacement amount of the piezoelectric actuator 300 depends on the voltage is referred to as linearity. The voltage in linearity is the potential difference Vh in the drive waveform DP illustrated in FIG. 6.

y=ax Ln(x)+b (Expression 4)

Here, y is the displacement amount, and x is the reference Vh.

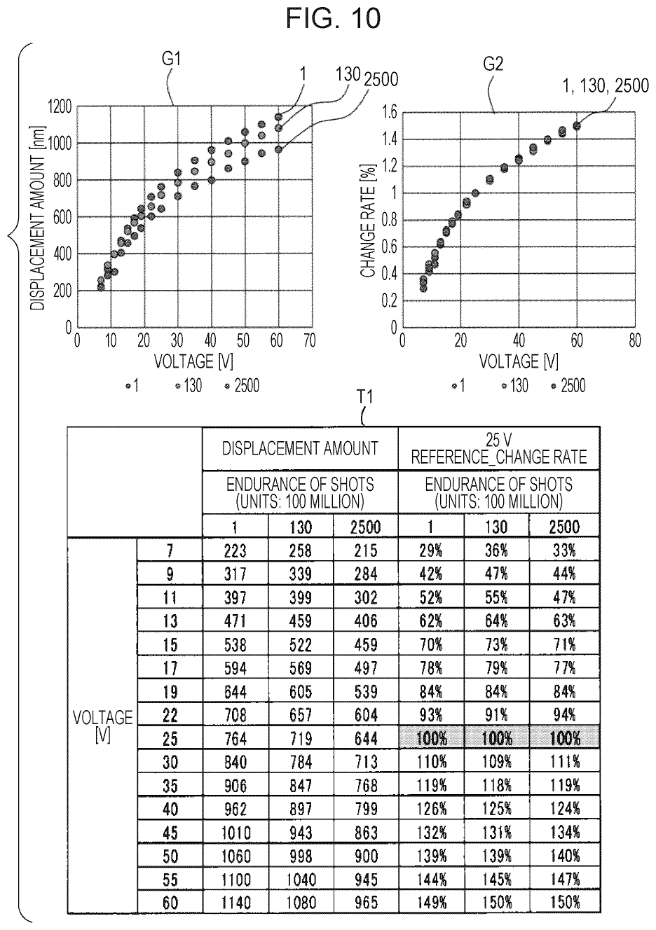

FIG. 10 illustrates linearity before and after endurance. In a graph G1 in the drawing, a horizontal axis represents a voltage [V] and a vertical axis represents a displacement amount [nm]. In the graph G2, a horizontal axis represents a voltage [V] and a vertical axis represents a change rate [%]. The voltage is the potential difference Vh of the drive waveform DP. In the graphs G1 and G2, “1” indicates the linearity of the piezoelectric actuators 300 to which a drive waveform of 100 million shots is applied. Similarly, “130” indicates the linearity of the piezoelectric actuator 300 to which a drive waveform of 13 billion shots is applied, and “2500” indicates the linearity of the piezoelectric actuator to which a drive waveform of 250 billion shots is applied.

As shown in the “displacement amount” of the graph G1 and a table T1, the displacement amount changes depending on the voltage. The degree of change amount varies depending on the endurance, that is, the number of shots of the drive waveform DP. In this example, the displacement amount is smaller in a case where endurance of 13 billion shots is performed than in a case where endurance of 100 million shots is performed, and the displacement amount is smaller in a case where endurance of 250 billion shots is performed than in a case where endurance of 13 billion shots is performed.

The graph G2 is obtained by converting the displacement amount in the graph G1 into a change rate. Here, the displacement amount when the voltage is 25 V is used as a reference, and the ratio of the displacement amount at each voltage to the displacement amount used as a reference is a change rate. The above-described reference Vh is the potential difference Vh set as a reference in this way. As shown in the graph G2 and the “25 V reference change rate” of the table 1, the change rate changes depending on the voltage, but it can be seen that the change rate is substantially the same even when the endurance is different. For example, the change rate corresponding to a voltage of 19 [V] is 84% for all shot counts.

In this way, when a specific voltage is used as a reference, the change rate in linearity is substantially the same even when the degree of endurance is different, so Vh in the table T1 can be regarded as the corrected Vh, and the change rate in each voltage can be regarded as the correction amount dc. For example, it is assumed that the piezoelectric actuators 300 using the drive waveform with a potential difference Vh of 25 V deteriorates and the correction amount is 10%. In this case, the original displacement amount can be restored by setting 30 V corresponding to 110% as the corrected Vh.

Such a relationship between the correction amount de and the corrected Vh can be well approximated by a quadratic function shown in Expression 3. The coefficients A, B, and C in Expression 3 can be approximated by a linear equation with the reference Vh as a variable as shown in Expression 1 and As, Ai, Bs, Bi, Cs, and Ci as coefficients. It is known that As, Ai, Bs, Bi, Cs, and Ci are values determined by the linearity of the piezoelectric actuator 300.

Since As, Ai, Bs, Bi, Cs, and Ci are unique values determined by the configuration of the liquid ejecting head H, the shape and material of the piezoelectric actuator 300, and the like, coefficients thereof are experimentally obtained in advance and stored in the storage section 212 when, for example, the liquid ejecting head H is manufactured and shipped.

Then, as described above, the waveform adjustment section 242 calculates the corrected Vh using the deterioration rate acquired by the acquisition section 241, the reference Vh applied to the drive waveform, Expression 1, and the coefficients A to C obtained based on the linearity, and corrects the drive waveform so as to obtain the corrected Vh. In this way, the drive waveform is adjusted according to the deterioration rate dr, whereby the displacement amount of the piezoelectric actuator 300 increases by the correction amount, and the original displacement amount can be restored.

The time acquisition section 243 acquires information regarding the time during which the liquid ejecting head H is used. Hereinafter, the information is referred to as use time information. An example of the time during which the liquid ejecting head His used includes an integrated time during which electric power is supplied to the liquid ejecting head H. Another example includes an integrated time during which the liquid ejecting head H ejects the liquid. The time acquisition section 243 stores such use time information in the storage section 212. The use time information acquired by the time acquisition section 243 can be referenced by the waveform adjustment section 242.

The count acquisition section 244 acquires information regarding the count of liquid ejection from the liquid ejecting head H. Hereinafter, the information is referred to as ejecting count information. The ejecting count information can be obtained by, for example, integrating the number of drive waveforms DP applied to the piezoelectric actuator 300. Alternatively, the ejecting count information may be acquired by capturing the liquid droplets ejected from the nozzles 21, detecting the liquid droplets from the image obtained by the capturing using a known image processing method, and integrating the number of the detected liquid droplets.

The liquid ejecting head H is provided with the plurality of nozzles 21. Therefore, the ejecting count information may be acquired for the liquid ejected from a specific nozzle 21. Alternatively, an average value, a maximum value, a minimum value, a total value, or the like of the counts of liquid ejection from the plurality of nozzles 21 may be used as the ejecting count information. The count acquisition section 244 stores such ejecting count information in the storage section 212. The ejecting count information acquired by the count acquisition section 244 can be referenced by the waveform adjustment section 242.

The waveform adjustment section 242 preferably adjusts the drive waveform when the use time information acquired by the time acquisition section 243 exceeds a predetermined threshold count. In addition, the waveform adjustment section 242 preferably adjusts the drive waveform when the ejecting count information acquired by the count acquisition section 244 exceeds a predetermined threshold count. Furthermore, that the waveform adjustment section 242 preferably adjusts the drive waveform in a case of receiving an input indicating that the adjustment of the drive waveform is necessary from the operation device 9b, which receives an input from the user regarding whether the adjustment of the drive waveform is necessary. Naturally, the waveform adjustment section 242 can adjust the drive waveform at any timing.

The aging processing section 245 reduces, in accordance with the degree of deterioration of the piezoelectric actuator 300, the displacement amount of the piezoelectric actuator 300 by driving the piezoelectric actuator 300 before printing. In the present embodiment, the aging processing section 245 performs the aging processing by driving the piezoelectric actuator 300 with the same drive signal as the drive signal (COM) used to eject ink droplets. The time taken for the aging processing is referred to as a voltage application time. The displacement amount can be reduced to a desired amount by appropriately adjusting the voltage application time. The aging processing section 245 may drive the piezoelectric actuator 300 using a drive signal having a drive waveform dedicated to aging, which is different from the drive signal (COM) used to eject ink droplets.

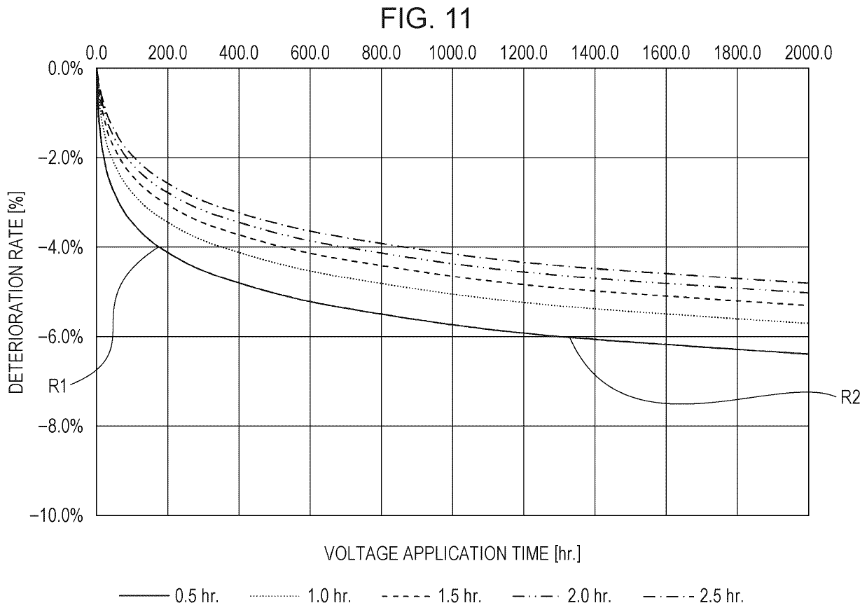

In the aging processing, a corresponding relationship information is used that indicates a corresponding relationship between the drive time and the deterioration rate of the piezoelectric actuator 300. FIG. 11 illustrates a corresponding relationship information. A horizontal axis represents a voltage application time, and a vertical axis represents a deterioration rate.

The drawing shows a relationship between the voltage application time and the deterioration rate when the piezoelectric actuators 300 are continuously driven after the aging processing in a case where the drive time for which the piezoelectric actuators 300 are driven is changed from 0.5 hours (0.5 hr.) to 2.5 hours (2.5 hr.) in increments of 0.5 hours (0.5 hr.).

The deterioration rate of the piezoelectric actuator 300 decreases as the voltage application time increases regardless of the drive time during the aging processing. However, the change in the deterioration rate becomes gentler after the voltage application time becomes long to a certain extent. As described above, although the degree of the deterioration rate differs depending on the drive time at the initial stage of driving, the tendency is common that the deterioration rate decreases depending on the voltage application time.

For example, a case will be described in which the deterioration rate of the piezoelectric actuators 300, for which the drive time at the initial stage of driving is 0.5 hr., acquired by the acquisition section 241 is −4% and the displacement amount of the piezoelectric actuators 300 are reduced to −6%. In this case, the aging processing section 245 uses the corresponding relationship information for the drive time of 0.5 hr. indicated by a solid line. Then, the aging processing section 245 obtains 1020 hr., which is a difference between approximately 180 hr. which is the voltage application time corresponding to −4% indicated by a point R1 and approximately 1300 hours which is the voltage application time corresponding to −6% indicated by a point R2. The aging processing section 245 applies the drive waveform to the piezoelectric actuators 300 for 1020 hr. Thus, the displacement amount of the piezoelectric actuator 300 can be reduced from the state in which the deterioration rate is −4% to −6%.

It is preferable that the corresponding relationship information is accumulated in an external memory provided outside the liquid ejecting apparatus 1, and the aging processing section 245 acquires the corresponding relationship information from the external memory. Examples of the external memory include a storage medium physically connected to the liquid ejecting apparatus 1 and a server connected to the liquid ejecting apparatus 1 via a network such as the Internet or a public telephone network. Naturally, the corresponding relationship information may be accumulated, for example, in the storage section 212 of the liquid ejecting apparatus 1 without being limited to be accumulated in the external memory, and the aging processing section 245 may acquire the corresponding relationship information from the storage section 212.

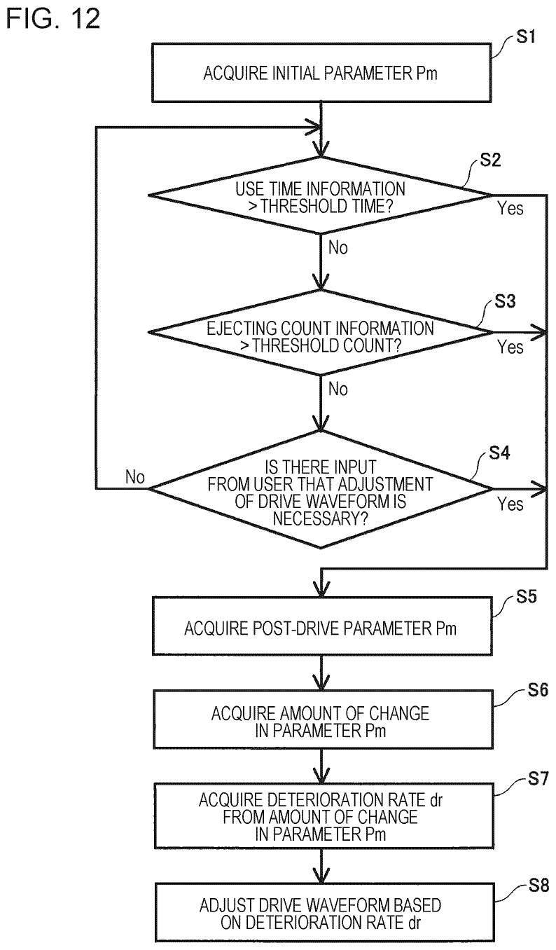

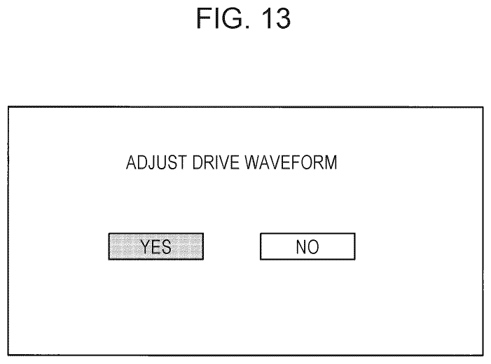

A description will be given with reference to FIGS. 12 and 13 with respect to the above-described method of acquiring the deterioration state (deterioration rate) using the acquisition section 241 and subsequent adjustment of the drive waveform. FIG. 12 is a flowchart illustrating a method of acquiring the deterioration rate of the liquid ejecting apparatus 1. FIG. 13 is an example of a screen displayed on the display device 9a. Although the parameter Pm will be described herein, the same applies to a case where the parameter Pm-Pr or the parameter Pr is used.

First, the initial parameter Pm is acquired when, for example, the liquid ejecting head H is manufactured and shipped (step S1). Specifically, as described above, the acquisition section 241 supplies the current detection signal to the piezoelectric actuator 300 and acquires the integral value of the current flowing through the piezoelectric actuator 300. Then, the acquisition section 241 stores the integral value as the initial parameter Pm in the storage section 212 or the like.

Next, it is determined whether the use time information exceeds a threshold time (step S2). Specifically, the waveform adjustment section 242 makes the determination by referring to the use time information acquired by the time acquisition section 243 and comparing the use time information with a threshold time stored in the storage section 212 in advance.

When the use time information is equal to or less than the threshold time (step S2: No), it is determined whether the ejecting count information exceeds the threshold count (step S3). Specifically, the waveform adjustment section 242 makes the determination by referring to the ejecting count information acquired by the count acquisition section 244 and comparing the ejecting count information with the threshold count stored in advance in the storage section 212.

When the ejecting count information is equal to or less than the threshold count (step S3: No), it is determined whether the user has input that adjustment of the drive waveform is necessary (step S4). For example, a screen as illustrated in FIG. 13 is displayed on the display device 9a (see FIG. 1) in response to an operation of the user, and the user operates the operation device 9b (see FIG. 1) to input that the adjustment of the drive waveform is necessary. When there is no such input (step S4: No), the process returns to step S2 after a predetermined time has elapsed. In practice, step S4 is not necessarily performed in the order of step S2 and step S3, and is an event generated by the operation of the user.

When the use time information exceeds the threshold time (step S2: Yes), when the ejecting count information exceeds the threshold count (step S3: Yes), and when the user inputs that the adjustment of the drive waveform is necessary (step S4: Yes), the post-drive parameter Pm is acquired (step S5). Specifically, as described above, the acquisition section 241 acquires the post-drive parameter Pm.

Next, the amount of change in the parameter Pm is calculated from the initial parameter Pm and the post-drive parameter Pm (step S6). Then, the deterioration rate dr is acquired from the amount of change in the parameter Pm (step S7). Specifically, the acquisition section 241 acquires the post-drive parameter Pm, and acquires the deterioration rate dr based on the relationship between the amount of change in the parameter Pm and the deterioration rate dr.

Next, the drive waveform is adjusted based on the deterioration rate dr obtained by the acquisition section 241 (step S8). Specifically, as described above, the waveform adjustment section 242 calculates the corrected Vh based on the deterioration rate dr, the potential difference Vh (reference Vh) of the drive waveform currently used, and Expression 1, and corrects the drive waveform so as to be the corrected Vh.

As described above, the liquid ejecting apparatus 1 according to the embodiment includes: the liquid ejecting head H including the nozzle 21 that ejects liquid, the pressure chamber 12, and the piezoelectric actuator 300 that applies pressure to the liquid in the pressure chamber 12 in order to eject the liquid from the nozzle 21; the drive signal generation section 213 that is a voltage application circuit which applies a voltage to the piezoelectric actuator 300; and the acquisition section 241 that acquires the deterioration rate, which is the degree of deterioration of the piezoelectric actuator 300, based on the information regarding the integral value of the current generated when the voltage applied to the piezoelectric actuator 300 is gradually changed from the first voltage to the second voltage.

When the current detection signal, which gradually changes from the first voltage to the second voltage, is applied to the piezoelectric actuator 300, the displacement amount of the diaphragm 50 of the piezoelectric actuator 300 changes. The information regarding the integral value of the current flowing through the piezoelectric actuator 300 while the current detection signal is applied is information that tends to decrease as the displacement amount of the piezoelectric actuator 300 deteriorates. Namely, it can be understood that the information regarding the integral value of the current is equivalent to direct measurement of a decrease in the displacement amount of the piezoelectric actuator 300. Therefore, the ratio before and after endurance of the obtained information regarding the integral value of the current directly indicates the degree of deterioration from the original displacement amount of the piezoelectric actuator 300, and it is possible to more accurately obtain the deterioration rate of the piezoelectric actuator 300 using the correlation illustrated in FIG. 7. In a state where the liquid ejecting head H is mounted on the liquid ejecting apparatus 1, since a special measurement device is separately required, it is difficult to directly measure the deterioration rate of the liquid ejecting head H. However, according to the liquid ejecting apparatus 1 of the present disclosure, the integral value of the current flowing through the piezoelectric actuator 300 can be obtained by the current detection section 216, and the deterioration rate can be obtained based on the integral value. Namely, it is possible to obtain the deterioration rate in a state where the liquid ejecting head H is mounted on the liquid ejecting apparatus 1 without the need for a special measurement device.

In the liquid ejecting apparatus 1 according to the embodiment, one of the first voltage and the second voltage is positive and the other is negative, the first voltage is a voltage which is substantially equal to the coercive electric field of the piezoelectric actuator 300, and the second voltage is a voltage which is substantially equal to a voltage at which the piezoelectric actuator 300 is saturated and polarized. As described above, the current detection signal used to obtain the parameter Pm has the first voltage that is negative and is substantially equal to the coercive electric field. The second voltage is substantially equal to the voltage at which the saturated polarization occurs. The first voltage being substantially equal to the coercive electric field means that the ratio of the first voltage to the coercive electric field (first voltage/coercive electric field) is 90% or more and 110% or less. The second voltage being substantially equal to the voltage at which the saturated polarization occurs means that the ratio of the second voltage to the voltage at which the saturated polarization occurs (second voltage/voltage at which saturated polarization occurs) is 90% or more and 110% or less. According to the liquid ejecting apparatus 1, since the parameter Pm, which is the integral value of the current, is equivalent to the maximum strain which is directly obtained, and the deterioration of the parameter Pm indicates the deterioration of the maximum strain, it is possible to obtain the deterioration rate based on the maximum strain of the piezoelectric actuator 300. The first voltage may be positive and the second voltage may be negative. For example, when the reference potential Vbs is applied to the second electrode 80 of the piezoelectric actuator 300 as a common electrode, the first voltage is positive and the second voltage is negative. Also in this case, similarly, the current detection signal, which gradually changes from the first voltage to the second voltage, is applied to the piezoelectric actuator 300, and the deterioration rate can be obtained based on the integral value of the current flowing through the piezoelectric actuator 300.

In the liquid ejecting apparatus 1 according to the embodiment, the drive signal generation section 213, which is a voltage application circuit, applies the drive waveform to the piezoelectric actuator 300 to eject liquid from the nozzle 21, the first voltage is the minimum voltage of the drive waveform, and the second voltage is the maximum voltage of the drive waveform. In the present embodiment, the minimum voltage of the drive waveform is the potential difference between the first potential V1 and the reference potential Vbs, and the maximum voltage is the potential difference between the second potential V2 and the reference potential Vbs. The minimum voltage of the drive waveform is substantially equal to the coercive electric field, and the maximum voltage is substantially equal to the voltage at which saturated polarization occurs. Therefore, as described above, the deterioration rate based on the maximum strain of the piezoelectric actuator 300 can be obtained based on the parameter Pm.

In the liquid ejecting apparatus 1 according to the embodiment, the first voltage is a voltage substantially equal to 0, and the second voltage is a voltage substantially equal to a voltage at which the piezoelectric body is saturated and polarized. As described above, the current detection signal used to obtain the parameter Pm-Pr has the first voltage of zero, and the second voltage is substantially equal to the voltage at which the saturated polarization occurs. According to the liquid ejecting apparatus 1, since the parameter Pm-Pr, which is the integral value of the current, is equivalent to the dielectric constant obtained directly, and the deterioration of the parameter Pm-Pr indicates the deterioration of the dielectric constant, it is possible to obtain the deterioration rate based on the dielectric constant of the piezoelectric actuator 300.

In the liquid ejecting apparatus 1 according to the present embodiment, the first voltage is a voltage substantially equal to the coercive electric field of the piezoelectric actuator 300, and the second voltage is 0 V. As described above, the current detection signal used to obtain the parameter Pr, the first voltage is substantially equal to the coercive electric field, and the second voltage is 0 V. According to the liquid ejecting apparatus 1, since the parameter Pr, which is the integral value of the current, is equivalent to the residual strain obtained directly, and the deterioration of the parameter Pr indicates the deterioration of the residual strain, it is possible to obtain the deterioration rate based on the residual strain of the piezoelectric actuator 300.

In the liquid ejecting apparatus 1 according to the embodiment, the drive signal generation section 213, which is a voltage application circuit, applies the drive waveform to the piezoelectric actuator 300 to eject liquid from the nozzle 21, and the liquid ejecting apparatus 1 further includes the waveform adjustment section 242 that adjusts the drive waveform in accordance with the degree of deterioration of the piezoelectric actuator 300. Since the deterioration rate of the piezoelectric actuator 300 acquired by the acquisition section 241 is accurate, it is possible to more accurately adjust the displacement amount of the piezoelectric actuator 300 to the displacement amount before the deterioration using the drive waveform adjusted based on the deterioration rate.

In the liquid ejecting apparatus 1 according to the embodiment, the drive waveform is a waveform in which the intermediate voltage, the expansion voltage for expanding the pressure chamber 12, the contraction voltage for contracting the pressure chamber 12, and the intermediate voltage are applied in this order.

In the liquid ejecting apparatus 1 according to the embodiment, the waveform adjustment section 242 adjusts the drive waveform such that the reference Vh, which is the difference between the expansion voltage and the contraction voltage increases as the degree of deterioration of the piezoelectric actuator 300 increases. As illustrated in the column of 100 million shots of the table T1 in FIG. 10, when the user wants to restore 10% from 100% (indicated as 110% in the table T1), the user needs to correct the reference Vh of 25 [V] to the corrected Vh of 30 [V]. On the other hand, when the user wants to restore 19% from 100%, the user needs to correct the reference Vh of 25 [V] to the corrected Vh of 35 [V]. In this way, since the reference Vh increases as the degree of deterioration of the piezoelectric actuator 300 increases, in other words, as the correction amount increases, it is possible to recover the displacement amount closer to the original displacement amount.

The liquid ejecting apparatus 1 according to the embodiment further includes the time acquisition section 243 that acquires the use time information, which is information regarding the time during which the liquid ejecting head H is used, and the waveform adjustment section 242 adjusts the drive waveform when the use time information acquired by the time acquisition section 243 exceeds a predetermined threshold time. According to the liquid ejecting apparatus 1, it is possible to automatically adjust the drive waveform at a timing at which it is estimated that the displacement amount of the piezoelectric actuator 300 deteriorates to a considerable extent.

The liquid ejecting apparatus 1 according to the present embodiment further includes the count acquisition section 244 that acquires the ejecting count information which is information regarding the count of liquid ejection from the liquid ejecting head H, and the waveform adjustment section 242 adjusts the drive waveform when the ejecting count information acquired by the count acquisition section 244 exceeds a predetermined threshold count. According to the liquid ejecting apparatus 1, it is possible to automatically adjust the drive waveform at a timing at which it is estimated that the displacement amount of the piezoelectric actuator 300 deteriorates to a considerable extent.

The liquid ejecting apparatus 1 according to the embodiment further includes the operation device 9b that receives the input from the user regarding whether the adjustment of the drive waveform is necessary, and the waveform adjustment section 242 adjusts the drive waveform when the operation device 9b receives the input indicating that the adjustment of the drive waveform is necessary. According to the liquid ejecting apparatus 1, it is possible to automatically adjust the drive waveform at a timing desired by the user.

The liquid ejecting apparatus 1 according to the embodiment further includes the aging processing section 245 that performs the aging processing to reduce, in accordance with the degree of deterioration of the piezoelectric actuator, the displacement amount of the piezoelectric actuator 300 by driving the piezoelectric actuator 300 before the printing. It is possible to perform the aging processing according to a request of the user in a state where the liquid ejecting head H is mounted on the liquid ejecting apparatus 1. For this reason, it is possible to prevent the liquid ejecting head H from failing to meet the request of the user, and to improve the satisfaction of the user.

The liquid ejecting apparatus 1 according to the present embodiment includes: the liquid ejecting head H including the nozzle 21 that ejects liquid, the pressure chamber 12, and the piezoelectric actuator 300 that applies pressure to the liquid in the pressure chamber 12 in order to eject the liquid from the nozzle 21; the drive signal generation section 213 that is a voltage application circuit which applies a voltage to the piezoelectric actuator 300; and the acquisition section 241 that acquires the degree of deterioration of the piezoelectric actuator 300, based on the information regarding the maximum strain or residual strain of the piezoelectric actuator 300. In the above-described embodiment, the parameters Pm and Pr obtained from the integral value of the current flowing through the piezoelectric actuator 300 represent the maximum strain and the residual strain, respectively, but the integral value of the current may not necessarily be used. Namely, the degree of deterioration of the piezoelectric actuator 300 may be directly obtained by measuring the maximum strain or the residual strain of the piezoelectric actuator 300 and comparing the values of the maximum strain or the residual strain before and after the endurance.

The acquisition method of the deterioration state of the liquid ejecting apparatus 1 according to the embodiment includes: applying the current detection signal, which is the voltage gradually changed from the first voltage to the second voltage, to the piezoelectric actuator 300; integrating the current generated by the application of the current detection signal to acquire the parameters Pm, Pm-Pr, and Pr which are information regarding the integral value; and acquiring the degree of deterioration of the piezoelectric actuator 300, based on the information. The information regarding the integral value of the current obtained by the acquisition method can be considered to be equivalent to direct measurement of the decrease in the displacement amount of the piezoelectric actuator 300. Therefore, the ratio before and after endurance of the obtained information regarding the integral value of the current directly indicates the degree of deterioration from the original displacement amount of the piezoelectric actuator 300, and it is possible to more accurately obtain the deterioration rate of the piezoelectric actuator 300 using the correlation illustrated in FIG. 7.

### OTHER EMBODIMENTS

Although each embodiment of the present disclosure has been described above, the basic configuration of the present disclosure is not limited to the above embodiments.

For example, the three types of parameters Pm, Pm-Pr, and Pr are exemplified in the first embodiment described above, but the acquisition section 241 may adopt any one of these parameters, or may adopt a plurality of parameters. When a plurality of parameters are used, a deterioration rate corresponding to each parameter is obtained. The acquisition section 241 may select any one of the plurality of deterioration rates, or may adopt, for example, an average value, a maximum value, or a minimum value of the plurality of deterioration rates as the deterioration rate.

In the first embodiment described above, the change in current when the voltage is changed from the low voltage to the high voltage is detected in order to obtain the parameters Pm, Pm-Pr, and Pr, but the change in current when the voltage is changed from the high voltage to the low voltage may be detected. In this case, the lower path in the hysteresis loop in FIG. 9 is followed instead of the upper path, but when the piezoelectric body is used whose characteristics are substantially the same when the voltage is changed from the high voltage to the low voltage and when the voltage is changed from the low voltage to the high voltage (the hysteresis loop is substantially point symmetrical), substantially the same results can be obtained even when the lower path is used.

Although a case has been described in the first embodiment in which the thin-film type piezoelectric actuator 300 is used as the driving element for generating a pressure change in the pressure chamber 12, the present disclosure is not particularly limited thereto, and a thick-film type piezoelectric actuator formed by a method of attaching a green sheet or the like, a longitudinal vibration type piezoelectric actuator in which a piezoelectric material and an electrode forming material are alternately laminated to expand and contract in the axial direction, or the like can be used.

Further, the present disclosure is directed to a general liquid ejecting apparatus including a liquid ejecting head. Examples of the liquid ejecting heads include recording heads such as various ink jet recording heads used in an image recording apparatus such as a printer, and coloring material ejecting heads used for manufacturing a color filter of a liquid crystal display or the like. In addition, examples of the liquid ejecting heads include an electrode material ejecting head used for forming an electrode of an organic EL display, a field emission display (FED), or the like, a bio-organic material ejecting head used for manufacturing a biochip, and the like, and the present disclosure can be applied to a liquid ejecting apparatus including these liquid ejecting heads.

### SUPPLEMENTARY NOTES

From the above-described exemplary embodiments, the following configurations can be understood, for example.

A liquid ejecting apparatus according to a first aspect, which is a preferred aspect, includes: a liquid ejecting head including a nozzle that ejects liquid, a pressure chamber, and a piezoelectric body that applies pressure to the liquid in the pressure chamber to eject the liquid from the nozzle; a voltage application circuit configured to apply a voltage to the piezoelectric body; and an acquisition section configured to acquire a degree of deterioration of the piezoelectric body, based on information regarding an integral value of a current generated when the voltage applied to the piezoelectric body is gradually changed from a first voltage to a second voltage.

According to this, the information regarding the integral value of the current is information that tends to decrease as the displacement amount of the piezoelectric body deteriorates. Therefore, it is possible to directly obtain the degree of deterioration from the original displacement amount of the piezoelectric body based on the obtained information regarding the integral value of the current, and it is possible to more accurately obtain the degree of deterioration of the piezoelectric body.

In a second aspect which is a specific example of the first aspect, one of the first voltage and the second voltage is positive and the other is negative, the first voltage is a voltage that is substantially equal to a coercive electric field of the piezoelectric body, and the second voltage is a voltage that is substantially equal to a voltage at which the piezoelectric body is saturated and polarized. Since the information regarding the integral value of the current represents the maximum strain of the piezoelectric body, it is possible to obtain the degree of deterioration based on the maximum strain of the piezoelectric body.

In a third aspect which is a specific example of the first or second aspect, the voltage application circuit applies a drive waveform to the piezoelectric body to eject liquid from the nozzle, the first voltage is a minimum voltage of the drive waveform, and the second voltage is a maximum voltage of the drive waveform. Since the information regarding the integral value of the current represents the maximum strain of the piezoelectric body, it is possible to obtain the degree of deterioration based on the maximum strain of the piezoelectric body.

In a fourth aspect which is a specific example of the first aspect, the first voltage is a voltage substantially equal to 0, and the second voltage is a voltage substantially equal to a voltage at which the piezoelectric body is saturated and polarized. Since the information regarding the integral value of the current represents the dielectric constant of the piezoelectric body, it is possible to obtain the degree of deterioration based on the dielectric constant of the piezoelectric body.

In a fifth aspect which is a specific example of the first aspect, the first voltage is a voltage substantially equal to a coercive electric field of the piezoelectric body, and the second voltage is 0 V. Since the information regarding the integral value of the current represents the residual strain of the piezoelectric body, it is possible to obtain the degree of deterioration based on the residual strain of the piezoelectric body.

In a sixth aspect which is a specific example of the first aspect, the voltage application circuit applies a drive waveform to the piezoelectric body to eject a liquid from the nozzle, and the liquid ejecting apparatus further includes a waveform adjustment section configured to adjust the drive waveform in accordance with the degree of deterioration of the piezoelectric body. Since the degree of deterioration of the piezoelectric body acquired by the acquisition section is accurate, it is possible to more accurately adjust the displacement amount of the piezoelectric body to the displacement amount before the deterioration using the drive waveform adjusted based on the degree of deterioration.

In a seventh aspect which is a specific example of the sixth aspect, the drive waveform is a waveform in which an intermediate voltage, an expansion voltage for expanding the pressure chamber, a contraction voltage for contracting the pressure chamber, and an intermediate voltage are applied in this order.

In an eighth aspect which is a specific example of the seventh aspect, the waveform adjustment section adjusts the drive waveform such that a difference between the expansion voltage and the contraction voltage increases as the degree of deterioration of the piezoelectric body increases. It is possible to more accurately adjust the displacement amount of the piezoelectric body to the displacement amount before deterioration.

In a ninth aspect which is a specific example of the sixth aspect, the liquid ejecting apparatus further includes a time acquisition section configured to acquire information regarding a time during which the liquid ejecting head is used, the waveform adjustment section being configured to adjust the drive waveform when the information acquired by the time acquisition section exceeds a predetermined threshold time. The drive waveform can be adjusted at a timing at which it is estimated that the displacement amount of the piezoelectric body deteriorates to a considerable extent.

In a tenth aspect which is a specific example of the sixth aspect, the liquid ejecting apparatus further includes a count acquisition section configured to acquire information regarding a count of liquid ejection from the liquid ejecting head, the waveform adjustment section being configured to adjust the drive waveform when the information acquired by the count acquisition section exceeds a predetermined threshold count. The drive waveform can be adjusted at a timing at which it is estimated that the displacement amount of the piezoelectric body deteriorates to a considerable extent.

In an eleventh aspect which is a specific example of the sixth aspect, the liquid ejecting apparatus further includes a receiving section configured to receive an input from a user regarding whether adjustment of the drive waveform is necessary, and the waveform adjustment section adjusts the drive waveform when the receiving section receives the input indicating that the adjustment of the drive waveform is necessary. The drive waveform can be adjusted at a timing desired by the user.

In a twelfth aspect which is a specific example of the first aspect, the liquid ejecting apparatus further includes an aging processing section configured to perform aging processing to reduce, in accordance with the degree of deterioration of the piezoelectric body, a displacement amount of the piezoelectric body by driving the piezoelectric body before printing. It is possible to perform the aging processing according to a request of the user in a state where the liquid ejecting head is mounted on the liquid ejecting apparatus.

A liquid ejecting apparatus according to a thirteenth aspect, which is a preferred aspect, includes: a liquid ejecting head including a nozzle that ejects liquid, a pressure chamber, and a piezoelectric body that applies pressure to the liquid in the pressure chamber to eject the liquid from the nozzle; a voltage application circuit configured to apply a voltage to the piezoelectric body; and an acquisition section configured to acquire a degree of deterioration of the piezoelectric body, based on information regarding a maximum strain or a residual strain of the piezoelectric body. The degree of deterioration of the piezoelectric body can be obtained based on the maximum strain or the residual strain of the piezoelectric body.

A method of acquiring a deterioration state of a liquid ejecting apparatus according to a fourteenth aspect, which is a preferred aspect, the liquid ejecting apparatus including a nozzle that ejects liquid, a pressure chamber, and a piezoelectric body that applies pressure to the liquid in the pressure chamber to eject the liquid from the nozzle, the method including: applying a voltage, which is gradually changed from a first voltage to a second voltage, to the piezoelectric body; integrating a current generated by application of the voltage to acquire information regarding an integral value; and acquiring a degree of deterioration of the piezoelectric body, based on the information. The information regarding the integral value of the current is information that tends to decrease as the displacement amount of the piezoelectric body deteriorates. Therefore, it is possible to directly obtain the degree of deterioration from the original displacement amount of the piezoelectric body based on the obtained information regarding the integral value of the current, and it is possible to more accurately obtain the degree of deterioration of the piezoelectric body.

What is claimed is:

1. A liquid ejecting apparatus comprising:
a liquid ejecting head including a nozzle that ejects liquid, a pressure chamber, and a piezoelectric body that applies pressure to the liquid in the pressure chamber to eject the liquid from the nozzle;
a voltage application circuit configured to apply a voltage to the piezoelectric body; and
an acquisition section configured to acquire a degree of deterioration of the piezoelectric body, based on information regarding an integral value of a current generated when the voltage applied to the piezoelectric body is gradually changed from a first voltage to a second voltage.

2. The liquid ejecting apparatus according to claim 1, wherein one of the first voltage and the second voltage is positive and the other is negative,
the first voltage is a voltage that is substantially equal to a coercive electric field of the piezoelectric body, and
the second voltage is a voltage that is substantially equal to a voltage at which the piezoelectric body is saturated and polarized.

3. The liquid ejecting apparatus according to claim 1 or 2, wherein the voltage application circuit applies a drive waveform to the piezoelectric body to eject the liquid from the nozzle,
the first voltage is a minimum voltage of the drive waveform, and
the second voltage is a maximum voltage of the drive waveform.

4. The liquid ejecting apparatus according to claim 1, wherein the first voltage is a voltage substantially equal to 0, and
the second voltage is a voltage that is substantially equal to a voltage at which the piezoelectric body is saturated and polarized.

5. The liquid ejecting apparatus according to claim 1, wherein the first voltage is a voltage that is substantially equal to a coercive electric field of the piezoelectric body, and
the second voltage is 0 V.

6. The liquid ejecting apparatus according to claim 1, wherein the voltage application circuit applies a drive waveform to the piezoelectric body to eject the liquid from the nozzle, and
the liquid ejecting apparatus further comprises a waveform adjustment section configured to adjust the drive waveform in accordance with the degree of deterioration of the piezoelectric body.

7. The liquid ejecting apparatus according to claim 6, wherein the drive waveform is a waveform in which an intermediate voltage, an expansion voltage for expanding the pressure chamber, a contraction voltage for contracting the pressure chamber, and the intermediate voltage are applied in this order.

8. The liquid ejecting apparatus according to claim 7, wherein the waveform adjustment section adjusts the drive waveform such that a difference between the expansion voltage and the contraction voltage increases as the degree of deterioration of the piezoelectric body increases.

9. The liquid ejecting apparatus according to claim 6, further comprising a time acquisition section configured to acquire information regarding a time during which the liquid ejecting head is used,
the waveform adjustment section being configured to adjust the drive waveform when the information acquired by the time acquisition section exceeds a predetermined threshold time.

10. The liquid ejecting apparatus according to claim 6, further comprising a count acquisition section configured to acquire information regarding a count of liquid ejection from the liquid ejecting head,
the waveform adjustment section being configured to adjust the drive waveform when the information acquired by the count acquisition section exceeds a predetermined threshold count.

11. The liquid ejecting apparatus according to claim 6, further comprising a receiving section configured to receive an input from a user regarding whether adjustment of the drive waveform is necessary,
the waveform adjustment section being configured to adjust the drive waveform when the receiving section receives an input indicating that the adjustment of the drive waveform is necessary.

12. The liquid ejecting apparatus according to claim 1, further comprising an aging processing section configured to perform aging processing to reduce, in accordance with the degree of deterioration of the piezoelectric body, a displacement amount of the piezoelectric body by driving the piezoelectric body before printing.

13. A liquid ejecting apparatus comprising:
a liquid ejecting head including a nozzle that ejects liquid, a pressure chamber, and a piezoelectric body that applies pressure to the liquid in the pressure chamber to eject the liquid from the nozzle;
a voltage application circuit configured to apply a voltage to the piezoelectric body; and
an acquisition section configured to acquire a degree of deterioration of the piezoelectric body, based on information regarding a maximum strain or a residual strain of the piezoelectric body.

14. A method of acquiring a deterioration state of a liquid ejecting apparatus including a nozzle that ejects liquid, a pressure chamber, and a piezoelectric body that applies pressure to the liquid in the pressure chamber to eject the liquid from the nozzle, the method comprising:
applying a voltage, which is gradually changed from a first voltage to a second voltage, to the piezoelectric body;
integrating a current generated by application of the voltage to acquire information regarding an integral value; and
acquiring a degree of deterioration of the piezoelectric body, based on the information.
